(19) United States
(12) Patent Application Publication
(10) Pub. No.: US 2008/0148519 A1
(43) Pub. Date: Jun. 26, 2008

(54) HINGE ASSEMBLY

(76) Inventors: CHIH-CHING CHANG, Taipei (TW); Chun-Hsien Wu, Taiwan (TW)

Correspondence Address: G. LINK CO., LTD, 3550 BELL ROAD, MINOOKA, IL, 60447, US

(21) Appl. No.: 11/694,976

(22) Filed: Mar. 31, 2007

(30) Foreign Application Priority Data
Jan. 8, 2007 (TW) 096100731

(51) Int. Cl. E05D 7/00

(52) U.S. Cl. 16/354; 361/681

(57) ABSTRACT

The present invention relates to a hinge assembly that enables the adjustment of viewing angles of liquid crystal display monitor mounted thereon and has multiple structural features to enhance its loading performance when it carries large-size liquid crystal display. The hinge assembly is also easy to handle for users.

### FIELD OF THE INVENTION

The present invention relates to a hinge assembly, featuring multiple structural functions to enhance its load bearing capacity and easy handling by users.

### BACKGROUND OF THE INVENTION

The dawning of digital age, prevalence of Internet, and changes of digital broadcast signals have fueled the significant evolvement of display technology. Liquid crystal display (LCD) monitors offer the advantages of lightweight, thin form, power saving and free of radiation. It is expected to become the mainstream choice for computer monitor and home television. Generally a stand is needed for the placement of LCD monitor on a desk for support or adjustment of monitor angle.

In recent years, LCD monitor stand and LCD are commonly separately fabricated and then assembled. When a stand-included LCD monitor is placed on a desk, it is also easy to adjust the tilting angles of the LCD.

The recent trend is that LCD monitors marketed by different markers are increasing in size. More and more large-size and heavier LCD monitors are in mass production. When large-size LCD monitor is assembled to the stand, it puts the stand under greater loading. For example, when the LCD monitor stand is in a smaller forward-tilt angle, the stand structure bears less weight load. Conversely when the stand is adjusted to bigger forward-tilt angle, the entire stand structure is subject to greater weight load. Conventional LCD monitor stands are not designed to adapt to varying loading, therefore not having a structure to respond to different weight loads and unable to provide sturdy support when screen size and tilting angle change.

### SUMMARY OF THE INVENTION

The primary object of the invention is to provide a hinge assembly with increased load bearing capacity to meet the needs of large-size liquid crystal display.

The objects, features and effects of the invention are described in detail below with embodiments in reference to the accompanying drawings.

### BRIEF DESCRIPTION OF THE DRAWINGS

FIG. 1 is a perspective view of a preferred embodiment of the invention;

FIG. 2 is a partial exploded view of a preferred embodiment of the invention;

FIG. 3 is a partial perspective view of the first bracket element of the invention;

FIG. 4 is a partial perspective view of the second bracket element of the invention; and

FIG. 5 is a diagram showing the second elastic means and regulating device.

### DETAILED DESCRIPTION OF THE INVENTION

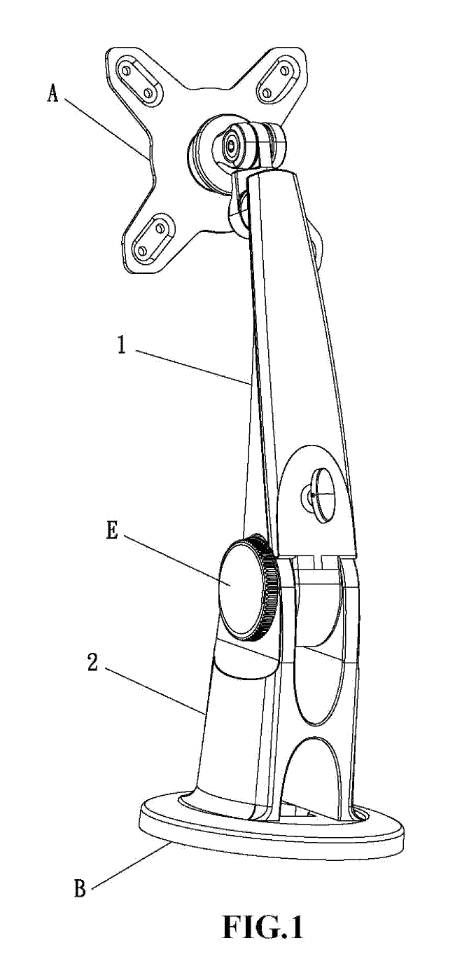

FIG. 1 shows a perspective view of a preferred embodiment of the invention. The present invention discloses a hinge assembly comprising a first bracket element 1 and a second bracket element 2, wherein the other end of the first bracket element 1 opposing the end where it is linked to the second bracket element 2 is provided with a connecting device A for connecting a LCD monitor not shown in the figure, and the other end of the second bracket element 2 opposing to the end where it is linked to the first bracket element 1 is arranged with a base B. Further details of the invention are described below.

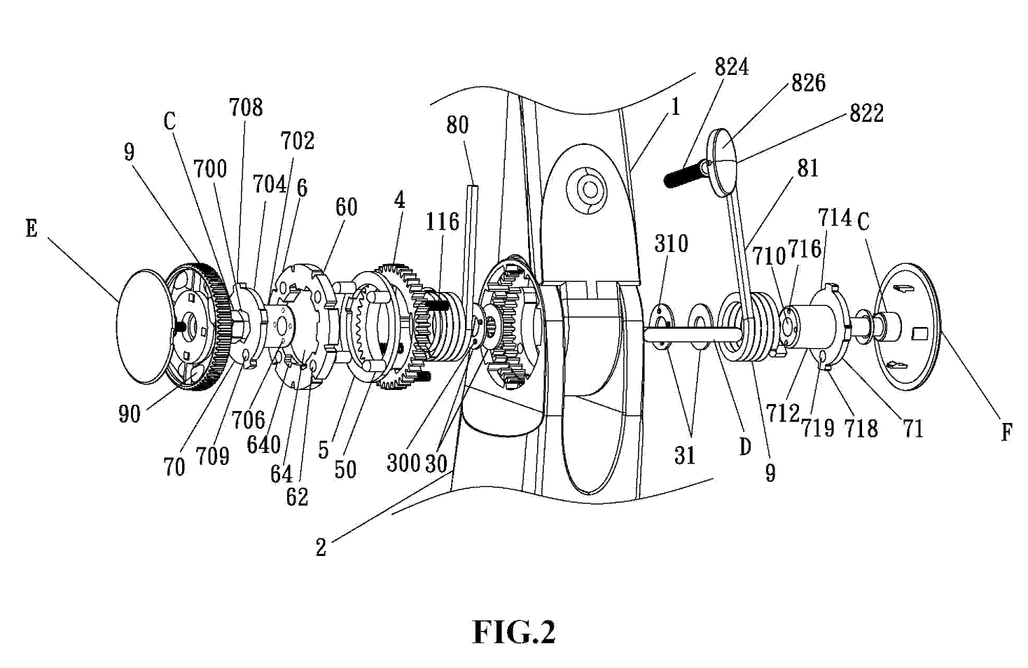

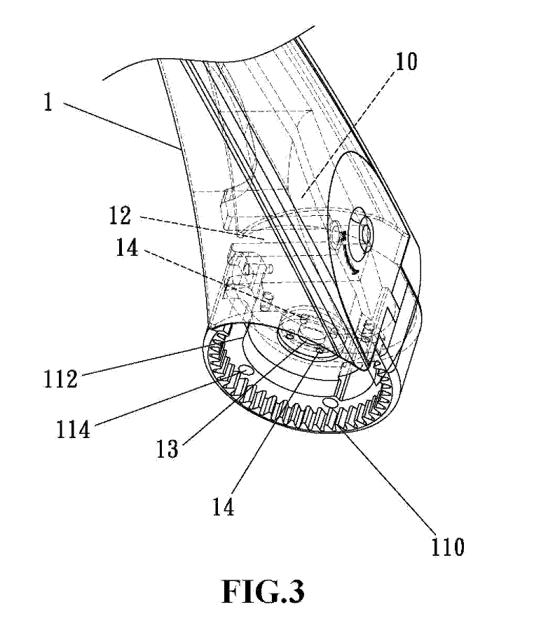

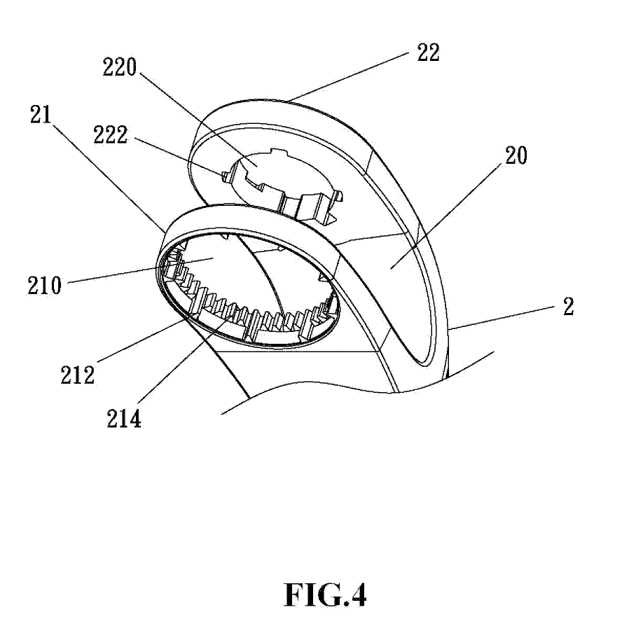

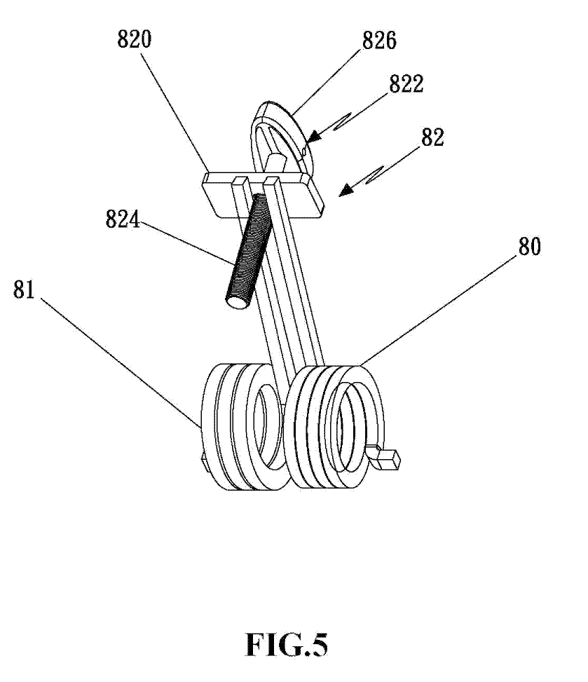

As shown in FIG. 2 which is a partial exploded view of a preferred embodiment of the invention, the first bracket element 1 has a first compartment 10 see FIG. 3, and the end of the first bracket element 1 where it is linked to the second bracket element 2 is provided with a second compartment 11 and a third compartment 12. The first compartment 10 communicates with the second compartment 11 and the third compartment 12, and an axle hole 13 passes through the second compartment 11 and the third compartment 12. A first positioning member 14 is provided on the surface on both sides of axle hole 13. The inner surface on one side of the second compartment 11 is disposed with a plurality of annularly distributed first gear blocks 110. The second compartment 11 next to the first gear blocks 110 is constricted into a rib-shape member 112 having a plurality of concavities 114 on its side surface for the arrangement of a plurality of first elastic means 116 thereon. The end of the second bracket element 2 see FIG. 4 where it is linked to the first bracket element 1 is provided with a fourth compartment 20 formed by two side flange members 21, 22. The space between the two side flange members 21, 22 can accommodate the end of the first bracket element 1 having the axle hole 13. On top of the two side flanges 21, 22 there provides respectively a fifth compartment 210 and a sixth compartment 220, which show circular hollow-through patterns. The inner surface of the fifth compartment 210 is disposed with a plurality of annularly distributed second gear blocks 212 and third gear blocks 214, wherein a plurality of the third gear blocks 214 are situated between every two gear blocks 212. The inner surface of the sixth compartment 220 is disposed with a plurality of first notches 222, two damping blocks 30, 31, where each damping block 30, 31 is made of two damping sheets in annular shape and hollow-through pattern. The surface of damping sheet other than the surface adjoining the other damping sheet is disposed with a plurality of protruding dots 300, 310. The protruding dots on the side surface of one damping sheet of each damping block 30, 31 match the first positioning member 14 on the side surface of axle hole 13. A wheel gear 4 in hollow-through pattern is able to move between the second compartment 11 and the fifth compartment 210, and engage the first gear blocks 110 disposed in the second compartment 11 and the second gear blocks 212 and the third gear blocks 214 disposed in the fifth compartment 210. One side plane of the wheel gear 4 is set against the first elastic means 116. A radial collar 5 in hollow-through pattern has one side plane set against the wheel gear 4 and the other side plane disposed with a plurality of protruding posts 50. A positioning annular block 6 is arranged in the fifth compartment 210 and has a plurality of second notches 60 on its annular surface, which can engage the second gear blocks 214. The positioning annular block 6 is disposed with a plurality of positioning through-holes 62 on its side surface to match the protruding posts of the radial collar 5 and configured with a through seventh compartment 64. The inner surface of the seventh compartment 64 is arranged with a plurality of third notches 640. A first axial block 70 is provided with a first hollow member 700 that is axially hollow through, and consists of a first columnar member 702 and a first cap member 704. The first columnar member 702 can pass through the wheel gear 4, the radial collar 5 and positioning annular block 6. Its bottom surface is disposed with a plurality of second positioning members 706, which match the protruding dots 300 on a side surface of another damping sheet of damping block 30. The first cap member 704 is arranged with a plurality of first positioning ribs 708 along its circumference which engage the third notches 640, and arranged with a first stop hole 709 on the side surface. A second axial block 71 is provided with a second hollow member 710 that is axially hollow through, and consists of a second columnar member 712 and a second cap member 714. The second columnar member 712 can be penetratively disposed in the sixth compartment 220. Its bottom surface is disposed with a plurality of third positioning members 716, which match the protruding dots 310 on a side surface of another damping sheet of another damping block 31. The second cap member 714 is arranged with a plurality of second positioning ribs 718 along its circumference which engage the first notches 222 disposed in the sixth compartment 220, and arranged with a second stop hole 719 on the side surface. Two second elastic means 80, 81 respectively sleeve over the first columnar member 702 and the second columnar member 712. One end of the two elastic means 80, 81 is disposed through the first stop hole 709 and the second stop hole 719 respectively, while the other end extends into the first compartment 10. The other end of the two second elastic means 80, 81 is disposed with a regulating device 82 as shown in FIG. 5. The regulating device 82 comprises an adjusting element 820 and a rotary element 822. The adjusting element 820 is disposed inside the first compartment 10 and set against the two second elastic means 80, 81. The rotary element 822 is composed of a screw member 824 and a knob member 826. The screw member passes through the adjusting element 820 and the first bracket element 1 to enable the knob member 826 to be disposed outside the first bracket element 1 in such a manner that when the knob member 826 is turned, the screw member 824 drives the displacement of the adjusting element 820, thereby changing the relative position of the second elastic means 80, 81 to the first compartment 10, and at the same time, changing the initial load bearing state of the second elastic means 80, 81. A rotary disc element 9 has one side surface in contact with a side surface of the positioning annular block 6, on which a plurality of inclined guide members 90 are disposed. The inclined guide members 90 are set against the protruding posts 50 disposed on the radial collar 5 in such a manner that when the rotary disc element 9 turns, it changes the load bearing state against the protruding post 50, thereby changing the relative position of wheel gear 4. After the assembly, the hinge assembly can be secured by passing a fixation set C through the first hollow member 700 of the first axial block 70, the second hollow member 710 of the second axial block 71, and the axle hole 13, or it can use a positioning pin D to render the assembly convenient this is a not feature of the invention and will not be elaborated here. Lastly for aesthetic sake, a first outer cover E and a second outer cover F are disposed on each side of the hinge assembly.

When the first bracket element 1 and the second bracket element 2 turn against each other, the resistance that prevents the relative rotation comes from the friction between the damping sheets of the damping blocks 31, 31 and the elasticity provided by the second elastic members 80, 81. The second elastic members 80, 81 can have their initial load-bearing state changed through the working of regulating device 82. As such, its load bearing capacity can be adjusted. When it is desired to completely stop the rotation of first bracket element 1 against the second bracket element 2, turning the rotary disc element 9 causes the protruding posts 50 to displace along the inclined guide members 90 through the recoil force of the first elastic means 116, and positions the wheel gear 4 between the second compartment 11 and the fifth compartment 210, while the wheel gear 4 engages the first gear blocks 110, the second gear blocks 212, and the third gear blocks 214 simultaneously. As such, the first bracket element 1 and the second bracket element 2 cannot turn against each other. Conversely, rotating the rotary disc element 9 to exert force on the protruding posts 50 will cause the wheel gear 4 to move and compress the first elastic means 116. As such, the first bracket element 1 and the second bracket element 2 are allowed to rotate against each other.

The hinge assembly according to the present invention provides multiple structures to enhance its load-bearing capacity, enable it to carry large-size LCD monitors, and make it easy and convenient for user to operate. Thus the present invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A hinge assembly, comprising:
a first bracket element having a first compartment, and having a second compartment and a third compartment at one end; the first compartment communicating with the second compartment and the third compartment, whereas the second compartment and the third compartment having an axle hole passing through; a first positioning member being provided on the surface on both sides of axle hole; the inner surface on one side of the second compartment being disposed with a plurality of annularly distributed first gear blocks; the second compartment next to the first gear blocks being constricted into a rib-shape member having a plurality of concavities on its side surface for the arrangement of a plurality of first elastic means thereon;
a second bracket element having a fourth compartment at one end; the fourth compartment being formed by two side flange members; the space between the two side flange members being able to accommodate the end of the first bracket element having the axle hole; a fifth compartment and a sixth compartment being provided on top of the two side flanges respectively, which show circular hollow-through patterns; the inner surface of the fifth compartment being disposed with a plurality of annularly distributed second gear blocks; the inner surface of the sixth compartment being disposed with a plurality of first notches;
two damping blocks, each being made of two damping sheets in annular shape and hollow-through pattern; the surface of damping sheet other than the surface adjoining the other damping sheet being disposed with a plurality of protruding dots; the protruding dots on the side surface of one damping sheet of each damping block matching the first positioning member disposed on the side surface of axle hole;
a wheel gear in hollow-through pattern, able to move between the second compartment and the fifth compartment and able to engage the first gear blocks disposed in the second compartment and the second gear blocks disposed in the fifth compartment; one side plane of the wheel gear being set against the first elastic means;
a radial collar in hollow-through pattern having one side plane set against the wheel gear and the other side plane disposed with a plurality of protruding posts;
a positioning annular block arranged in the fifth compartment and having a plurality of second notches on its annular surface, which engage the second gear blocks; the positioning annular block being disposed with a plurality of positioning through-holes on its side surface to match the protruding posts of the radial collar and configured with a through seventh compartment; the inner surface of the seventh compartment being arranged with a plurality of third notches;
a first axial block consisting of a first columnar member and a first cap member; the first columnar member being able pass through the wheel gear, the radial collar and the positioning annular block; its bottom surface being disposed with a plurality of second positioning members, which match the protruding dots on a side surface of another damping sheet of damping block; the first cap member being arranged with a plurality of first positioning ribs along its circumference, which engage the third notches, and the first cap member being arranged with a first stop hole on the side surface;
a second axial block consisting of a second columnar member and a second cap member; the second columnar member being able to penetratively dispose in the sixth compartment; its bottom surface being disposed with a plurality of third positioning members, which match the protruding dots on a side surface of another damping sheet of another damping block; the second cap member being arranged with a plurality of second positioning ribs along its circumference which engage the first notches disposed in the sixth compartment, and the second cap member being arranged with a second stop hole on the side surface;
two second elastic means sleeving respectively over the first columnar member and the second columnar member; one end of the two second elastic means being disposed through the first stop hole and the second stop hole respectively, while the other end extending into the first compartment; and
a rotary disc element having one side surface in contact with a side surface of the positioning annular block, on which a plurality of inclined guide members being disposed and set against the protruding posts disposed on the radial collar.

2. The hinge assembly according to claim 1, wherein the other surface of the rotary disc element is disposed with a first outer cover.

3. The hinge assembly according to claim 1, wherein a second outer cover is disposed outside the sixth compartment of the second axial block.

4. The hinge assembly according to claim 1, wherein the other end of the two second elastic means is disposed with a regulating device.

5. The hinge assembly according to claim 4, wherein the regulating device comprises an adjusting element and a rotary element; the adjusting element is disposed inside the first compartment and set against the two second elastic means; the rotary element is composed of a screw member and a knob member; the screw member passes through the adjusting element and the first bracket element to enable the knob member to be disposed outside the first bracket element.

6. The hinge assembly according to claim 1, wherein the other end of the first bracket element is disposed with a connecting device for connecting a liquid crystal display monitor.

7. The hinge assembly according to claim 1, wherein the other end of the second bracket element is a base.

8. The hinge assembly according to claim 1, wherein a plurality of third gear blocks are situated between every two gear blocks, and the wheel gear can engage the second gear blocks and the third gear blocks.
